(19) United States
(12) Patent Application Publication
(10) Pub. No.: US 2003/0171959 A1
(43) Pub. Date: Sep. 11, 2003

(54) Method and apparatus for generating an automobile insurance endorsement

(76) Inventor: David Galloway, West Chester, PA (US)

Correspondence Address: Louis M. Heidelberger, Esq., Reed Smith LLP, 2500 One Liberty Place, 1650 Market Street, Philadelphia, PA, 19103, US

(21) Appl. No.: 10/358,046

(22) Filed: Feb. 4, 2003

Related U.S. Application Data
(60) Provisional application No. 60/354,856, filed on Feb. 6, 2002.

(51) Int. Cl. G06F 17/60

(52) U.S. Cl. 705/4

(57) ABSTRACT

A method of establishing a policy modification for restoration of an automobile to pre-damage condition is disclosed. This method utilizes allowable parts in automobile repair in accordance with an insurance policy, including establishing a need to modify the policy, identifying a state of operation for the policy, identifying controlling legal authority for the policy, and modifying the policy. The restoration of a an automobile to a pre-damage condition includes using nonoriginal equipment manufacturer aftermarket crash parts, original equipment manufacturer crash parts, reconditioned parts, restoration parts, used parts, and repair parts sufficient to restore the automobile to its pre-damaged condition. The modifying of the policy includes a filtering of a comparison of the controlling legal authority to the one or more of the group.

### CROSS REFERENCE TO RELATED APPLICATIONS

N/A

### BACKGROUND OF THE INVENTION

1. Field of the Invention

The invention relates to insurance endorsements, and more specifically to a method and apparatus for generating an automobile insurance endorsement.

2. Description of the Background

Standard insurance endorsement language stating that parts of “like kind and quality” were allowable for use in repairs, and subsequent inclusion of non-original equipment manufacturer parts (“non-OEM”), including non-OEM crash parts, aged parts or parts other than new original equipment manufacturer parts in repairs, has recently been found to be an increasingly cumbersome practice by at least one controlling legal authority. This practice may present a difficulty when particular parts, such as non-OEM parts, including non-OEM crash parts, aged parts or parts other than new original equipment manufacturer parts that may be deemed not of “like kind and quality”, are actually used by insurance companies to repair policyholder's cars. This practice may be deemed to cause unrest among policyholders. As a result, automobile insurance companies are attempting to generate new endorsements or amendments to automobile policies that would more clearly specify the use of non-OEM parts, including non-OEM crash parts, aged parts, or parts other than new original equipment manufacturer parts in the repair of automobiles covered under the policies. However, numerous factors must be balanced in order to generate such endorsements, and thus the process of generating new endorsements has become difficult and cumbersome.

Thus, there exists a need to more easily generate endorsements and policy language to inform, and to make clear and unambiguous to, policyholders the intention of insurers to specify non-OEM parts, including non-OEM crash parts, aged parts or parts other than new original equipment manufacturer parts for automobile repair, and to thereby allow policyholders to more accurately determine the limits of insurance applicable to the physical damage coverage provided by their automobile policies.

### BRIEF DESCRIPTION OF THE DRAWINGS

Understanding of the present invention will be facilitated by consideration of the following detailed description of a preferred embodiment of the present invention taken in conjunction with the accompanying drawings, in which like numerals refer to like parts, and in which:

FIG. 1 is a flow diagram illustrating a method of generating an automobile endorsement;

FIG. 2 is a block diagram illustrating a manual implementation of the method of FIG. 1; and

FIG. 3 is a block diagram illustrating an automated implementation of the method of FIG. 1.

### DETAILED DESCRIPTION OF THE INVENTION

It is to be understood that the figures and descriptions of the present invention have been simplified to illustrate elements that are relevant for a clear understanding of the present invention, while eliminating, for purposes of clarity, many other elements found in an insurance system, method, and apparatus. Those of ordinary skill in the art will recognize that other elements are desirable and/or required in order to implement the present invention. However, because such elements are well known in the art, and because they do not facilitate a better understanding of the present invention, a discussion of such elements is not provided herein. Further, the disclosure hereinbelow is directed to all such variations and modifications to the filing of endorsements known to those skilled in the art.

Endorsements or Amendments to automobile policy provisions may become necessary when a demonstrated need or change exists, either in regulation or in the business environment. Changes in controlling legal authority, such as changes in judicial case law, or new statues or laws, may provide the motivation to generate endorsements. Alternatively, motivation for a change in automobile policy provisions may be provided due to confusion amongst policy holders, or due to a desire of an insurer to more clearly advise a policyholder of limitations on liability. However, any changes to policies must be valid in light of existing regulatory law.

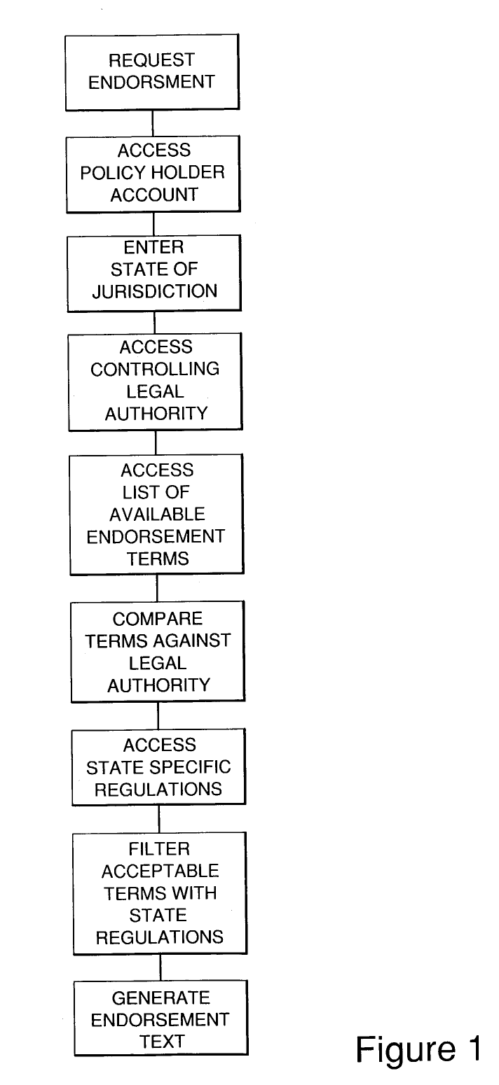

FIG. 1 is a flow diagram illustrating a method of generating an automobile endorsement. The method of FIG. 1 may be implemented manually, or may be implemented automatically, such as by the use of a computer. In accordance with a computer implemented method of the present invention, the computer program may be object oriented, or non-object oriented, and any reference herein directed to database may include relational or non-relational databases. The method of FIG. 1 may include the steps of weighing controlling legal authorities, comparing the terms allowed by the controlling legal authority to a list of unambiguous terms encompassed within the phrases “OEM”, “non-OEM”, and/or “crash” or “aged” parts and filtering the comparison by applying state regulations for individual states. As used herein, non-OEM includes parts not made by or for the manufacturer of the automobile, or an affiliate thereof, and/or parts not included in the original equipment of a typical like-vehicle.

In the first step of FIG. 1, wherein a first database of controlling legal authority is applied, controlling legal authority may vary by federal and/or state jurisdiction, and may take the form of statutory or judicial law, but does not include state regulatory law. For example, controlling legal authority in a given jurisdiction may find that the use of the terminology “like, kind and quality” in an insurance policy does not unambiguously notify the insured that non-OEM parts, including non-OEM crash parts, aged parts or parts other than new original equipment manufacturer parts, may be used in the repair of the insured's automobile. Thus, the use of non-OEM parts, including non-OEM crash parts, aged parts or parts other than new original equipment manufacturer parts during replacement or repair of the damaged automobile pursuant to a “like kind and quality” policy provision might be precluded or curtailed by that controlling legal authority, or might be found by that controlling legal authority to be, or not be, encompassed within the terminology “pre-damaged condition”, or like-terminologies employed to unambiguously inform an insured as to the parts eligible for use in a repair of the vehicle at issue. Controlling legal authority may be stored, for example, within a database, and the database may key each controlling authority to an applicable jurisdiction, such as by listing applicable states, or by listing “U.S.A” if applicable to all states.

The second step of the method of FIG. 1, the comparison of the list of terms encompassed within the allowable parts terminology, preferably includes a series of entries in a second database, wherein each entry is correspondent to a phrase that is encompassed, at least in part, within the definition of allowable parts. Each phrase in the database may preferably be assigned a priority for inclusion in a particular policy. For example, certain phrases may be most preferable to provide coverage to the insured for the use of certain types of parts, while other phrases may be less preferable. For example, phrases entered into the second database of the definition of allowable parts may include, for example, “non-original equipment manufacturer parts”, “after market parts”, “non-original equipment manufacturer after market crash parts”, “non-original equipment manufacturer crash parts”, “original equipment manufacturer crash parts”, “pre-damage aged parts”, pre-damage after market parts“, “pre-damage non-OEM new parts”, “reconditioned parts”, “restoration parts”, “used parts”, “repaired parts”, and/or “part that will restore the auto to its pre-damaged physical condition”. The second database may additionally include negative limitations on the definition of an allowable part, such as that the definition does NOT include “betterment” of a damaged vehicle, which may mean that a wear-out part may not be replaced with a new part, due to the fact that such a replacement would not have allowed for the wear on the replaced part. Thus, the second database includes clarifying terms, preferably as assessed by the insurer, on the types of parts that constitute the limitations on liability to return a vehicle to, for example, “pre-damaged condition”, and above which limitations the insured must cover costs for improvement on the pre-damaged condition.

It is preferred that a policy issued by the insurer pursuant to the present invention define, separately from the definition of allowable parts, that “pre-damaged physical condition” preferably does not include non-allowable parts, and does not require the replacement of, restoration of, or altering of parts that are not damaged in an accident, unless the part to be replaced is necessary for the operational safety of the damaged vehicle. Further, it may be stated that non-allowable parts that exceed the limitations on liability, such as, for example, new OEM parts, are not included within the definition of “pre-damaged physical condition”, even in the event that the damaged vehicle was a substantially new vehicle. Thus, the pre-damaged physical condition may be defined to include the functionality and appearance of an automobile immediately prior to the point at which the damage in question was sustained, and consequently may not require, for example, the use of new OEM parts. The second database may additionally include negative limitations, such as the phrase “betterment of the automobile”, or the like, that are not included within the allowable parts due to the provision, by those non-allowable parts, of improved physical condition over that immediately prior to the crash. For example, the term “betterment of a vehicle” may include the use of new OEM parts in an aged vehicle, and preferably the insurer is not liable for any betterment provided of an after crash vehicle due to the fact that the betterment is not included in the “pre-damaged physical condition”.

The third step in the method of FIG. 1 includes filtering the interaction of the first and second databases through a filter, such as the filter of state regulations. For example, New York state requires a certification of non-OEM crash parts by a certifying entity acceptable to that state's Superintendent of Insurance in order to allow the use of those crash parts pursuant to an insurance policy. Consequently, the filtering step may eliminate the use of non-OEM crash parts from the applied definition from the second database in a New York policy, despite the fact that non-OEM crash parts may be allowable under the controlling legal authority via the comparison of the second step. The filtering may provide a unique filter for each of the fifty states, or any number of jurisdictions therein, or any number of regions that include all or portions of the fifty states, and each of the exemplary fifty filters may be applied in sequence or in parallel to the interaction of the first and second databases. Additionally, the application of a filter or filters may allow for the accessing of an additional third database or databases that may include variations of the terms in the second database. Thereby, the filter may flag as not allowable a phrase from the second database that is allowable under controlling legal authority, but the filter may then access a third database, and search for similar phrases that would not be flagged by the state regulation filter. The text for the endorsement may then be generated as an output.

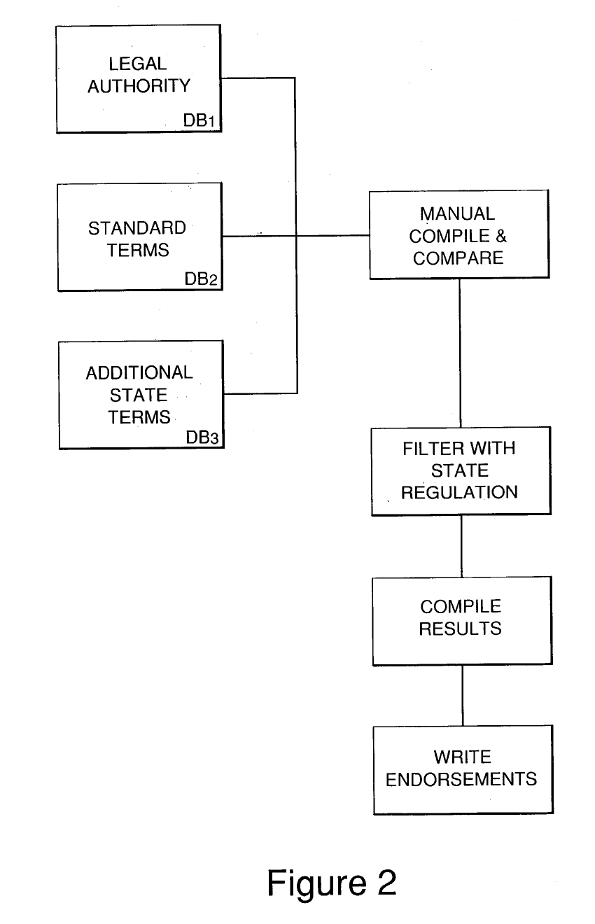

FIG. 2 is a block diagram illustrating a manual implementation of the method of FIG. 1. A user accesses the first, second, and/or the third databases employed in the method of FIG. 1, such as by reviewing paper manifests including thereon the list items from each of the databases. The data bases of FIG. 1 may include, as set forth hereinabove, the relevant legal authority for the jurisdiction of interest, the standard terms of industry useage for endorsements, and the additional state terms allowable for a specific jurisdiction. The user then selects the policy language for a given state by comparing the lists of the first and second database, and filtering eligible results by reviewing the list of state regulations. Additional terms allowable by the state of interest may then be incorporated into a policy. The user preferably compiles the selected information on the allowable terms prior to writing. The user then generates an endorsement, and/or a policy, in accordance with the language selected.

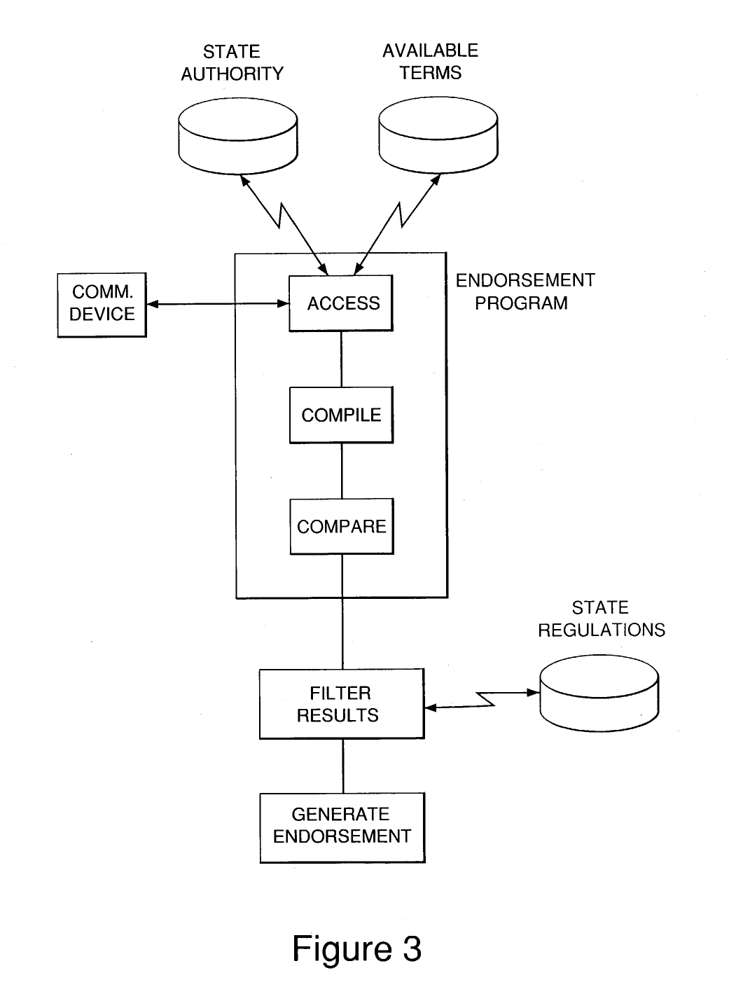

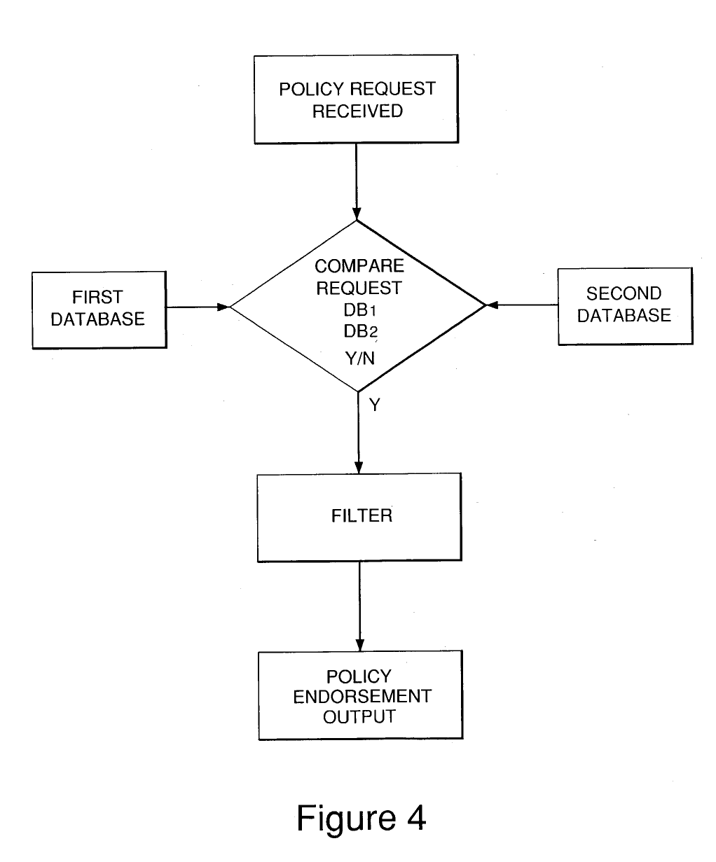

FIG. 3 is a block diagram illustrating an automated implementation of the method of FIG. 1. A computer, such as a desktop, laptop, PDA, web-phone, or the like, accesses the first, second, and/or the third databases employed in the method of FIG. 1. The computer then selects the policy language for a given state by comparing the lists of the first and second database, and filtering eligible results by reviewing the list of state regulations. Additional terms allowed by the jurisdiction of interest may then be added to the compiled data. The computer then generates an endorsement and/or a policy in accordance with the language selected.

A typical endorsement for the amendment of a personal insurance policy allowing the use of allowable parts, generated by the method and apparatus of FIGS. 1, 2, and 3 for Pennsylvania is as follows:

### AMENDMENT OF POLICY PROVISIONS—PENNSYLVANIA

### Personal Auto Policy

With respect to coverage provided by this endorsement, the provisions of your policy apply except as modified by this endorsement.

The terms and conditions of your policy are amended as indicated below.

### PART D—COVERAGE FOR DAMAGE TO YOUR AUTO

The LIMIT OF LIABILITY and PAYMENT OF LOSS sections of Part D of your policy are replaced with the following:

LIMIT OF LIABILITY

A. Our limit of liability for loss will be the lesser of:

1. The actual cash value of “your covered auto” or any “non-owned auto”, including its equipment; or

2. The amount necessary to restore “your covered auto” or “any non-owned auto”, including its equipment, to its “pre-damaged physical condition”. The determination of the amount necessary to restore the auto to its “pre-damaged physical condition” may, in our sole discretion, be based upon the use of “nonoriginal equipment manufacturer aftermarket crash parts”, “original equipment manufacturer crash parts”, reconditioned parts, restoration parts, used parts or any other repair or part, whether or not any such part was made by or for the original manufacturer or distributor of the auto, that will restore the auto to its “pre-damaged physical condition”. Restoring the auto to its “pre-damaged physical condition” does not require us to replace, restore or alter parts that are not damaged in the accident or loss, unless such part is needed for the operational safety of the vehicle; or

3. The amount shown in the Schedule or in the Declarations.

10 4. Any dispute with respect to the actual cash value of “your covered auto” or any “non-owned auto”, including its equipment, or the amount necessary to restore “your covered auto” or any “non-owned auto”, including its equipment, to its “pre-damaged physical condition”, including disputes concerning the parts we have selected in making that determination, shall be resolved pursuant to the binding appraisal process set forth in the “APPRAISAL” section below in this Part D of your Policy.

However, the most we will pay for loss to:

1. Any “non-owned auto” which is a trailer is $500:

2. Equipment designed solely for the reproduction of sound, including any accessories used with such equipment, which is installed in locations not used by the auto manufacturer for installation of such equipment or accessories, is $1,000.

B. An adjustment for depreciation and physical condition will be made in determining actual cash value in the event of a total loss.

C. If a repair or replacement part restores the auto to better than its “pre-damaged physical condition”, we will not pay for the amount of the “betterment”.

D. When used in this Part D, the terms listed below shall mean the following:

1. “Betterment”—The amount of increase to the pre-damaged or pre-loss cash value of an auto attributed to the use of replacement parts which are of a type that are normally subject to repair and replacement during the useful life of an auto including but not limited to tires and batteries.

2. “Nonoriginal equipment manufacturer aftermarket crash parts”—The replacement part, either new or used, for any of the nonmechanical parts that generally constitute the exterior of an auto, including but not limited to, inner and outer panels, and which was not made by or for the manufacturer of the auto.

3. “Original equipment manufacturer crash parts”—The replacement part, either new or used, for any of the nonmechanical parts that generally constitute the exterior of an auto including but not limited to, inner and outer panels, which was made by or for the manufacturer of the auto.

4. “Pre-damaged physical condition”—The operational safety, function and appearance of the auto immediately prior to when the damage in question was sustained.

PAYMENT OF LOSS

A. At our option we may:

(1) Pay either to replace or to repair “your covered auto” or “non owned auto”, including its equipment, but subject to the Limit of Liability set forth in this Part D;

(2) Return the stolen property, at our expense; or

(3) Take all or any part of the damaged or stolen property at an agreed or appraised value.

B. If we pay to replace “your covered auto” or any “non-owned auto” we will pay the applicable sales tax on the replacement cost of the auto.

C. If we return the stolen property at our expense, we will pay for any damage that results to the auto from the theft subject to the Limit of Liability set forth in this Part D.

A typical endorsement for the amendment of a personal policy allowing the use of allowable parts, generated by the method and apparatus of FIGS. 1, 2, and 3 for the state of Maryland follows:

### AMENDMENT OF POLICY PROVISIONS—MARYLAND

### Personal Auto Policy

With respect to coverage provided by this endorsement, the provisions of your policy apply except as modified by this endorsement.

The terms and conditions of your policy are amended as indicated below.

### PART D—COVERAGE FOR DAMAGE TO YOUR AUTO

The LIMIT OF LIABILITY and PAYMENT OF LOSS sections of Part D of your policy are replaced with the following:

LIMIT OF LIABILITY

C. Our limit of liability for loss will be the lesser of:

5. The actual cash value of “your covered auto” or any “non-owned auto”, including its equipment; or

6. The amount necessary to restore “your covered auto” or “any non-owned auto”, including its equipment, to its “pre-accident physical condition”. The determination of the amount necessary to restore the auto to its “pre-accident physical condition” may, in our sole discretion, be based upon the use of “nonoriginal equipment manufacturer aftermarket crash parts”, “original equipment manufacturer crash parts”, reconditioned parts, restoration parts, used parts or any other repair or part, whether or not any such part was made by or for the original manufacturer or distributor of the auto, that will restore the auto to its “pre-accident physical condition”. Restoring the auto to its “pre-accident physical condition” does not require us to replace, restore or alter parts that are not damaged in the accident or loss, unless such part is needed for the operational safety of the vehicle; or

7. The amount shown in the Schedule or in the Declarations.

8. Any dispute with respect to the actual cash value of “your covered auto” or any “non-owned auto”, including its equipment, or the amount necessary to restore “your covered auto” or any “non-owned auto”, including its equipment, to its “pre-accident physical condition”, including disputes concerning the parts we have selected in making that determination, shall be resolved pursuant to the binding appraisal process set forth in the “APPRAISAL” section below in this Part D of your Policy.

However, the most we will pay for loss to any “non owned auto” which is a trailer is $500.

D. An adjustment for depreciation and physical condition will be made in determining actual cash value in the event of a total loss.

E. If a repair or replacement part restores the auto to better than its “pre-accident physical condition”, we will not pay for the amount of the “betterment”.

F. When used in this Part D, the terms listed below shall mean the following:

5. “Betterment”—The amount of increase to the pre-accident or pre-loss cash value of an auto attributed to the use of replacement parts which are of a type that are normally subject to repair and replacement during the useful life of an auto including but not limited to tires and batteries.

6. “Nonoriginal equipment manufacturer aftermarket crash parts”—The exterior or interior sheet metal or fiberglass panels and parts which form the superstructure or body of a motor vehicle including but not limited to fenders, bumpers, quarter panels, door panels, hoods, grills, firewalls, permanent roofs, wheelwells, and front and rear lamp display panels which are manufactured by a person or entity other than the original manufacturer of the of the motor vehicle to be repaired or for which the manufacturer of the motor vehicle has not authorized the use of its name or trademark by the manufacturer of the part.

7. “Original equipment manufacturer crash parts”—The exterior or interior sheet metal or fiberglass panels and parts which form the superstructure or body of a motor vehicle including but not limited to fenders, bumpers, quarter panels, door panels, hoods, grills, firewalls, permanent roofs, wheelwells, and front and rear lamp display panels which are manufactured by the original manufacturer of the motor vehicle to be repaired or which are authorized to carry the name or trademark of the original manufacturer of the motor vehicle.

8. “Pre-accident physical condition”—The operational safety, function and appearance of the auto immediately prior to when the damage in question was sustained.

PAYMENT OF LOSS

A. At our option we may:

(4) Pay either to replace or to repair “your covered auto” or “non owned auto”, including its equipment, but subject to the Limit of Liability set forth in this Part D;

(5) Return the stolen property, at our expense; or

(6) Take all or any part of the damaged or stolen property at an agreed or appraised value.

D. If we pay to replace “your covered auto” or any “non-owned auto” we will pay the applicable sales tax on the replacement cost of the auto.

E. If we return the stolen property at our expense, we will pay for any damage that results to the auto from the theft subject to the Limit of Liability set forth in this Part D.

A typical endorsement for the amendment of a personal policy allowing the use of allowable parts, generated by the method and apparatus of FIGS. 1, 2, and 3 for the state of Michigan follows:

### AMENDMENT OF POLICY PROVISIONS—MICHIGAN

### Personal Auto Policy

With respect to coverage provided by this endorsement, the provisions of your policy apply except as modified by this endorsement.

The terms and conditions of your policy are amended as indicated below.

### PART D—COVERAGE FOR DAMAGE TO YOUR AUTO

The-LIMIT OF LIABILITY and PAYMENT OF LOSS sections of Part D of your POLICY are replaced with the following:

LIMIT OF LIABILITY

D. Our limit of liability for loss will be the lesser of:

9. The actual cash value of “your covered auto” or any “non-owned auto”, including its equipment; or

10. The amount necessary to restore “your covered auto” or “any non-owned auto”, including its equipment, to its “pre-accident physical condition”. The determination of the amount necessary to restore the auto to its “pre-accident physical condition” may, in our sole discretion, be based upon the use of “nonoriginal equipment manufacturer aftermarket crash parts”, “original equipment manufacturer crash parts”, reconditioned parts, restoration parts, used parts or any other repair or part, whether or not any such part was made by or for the original manufacturer or distributor of the auto, that will restore the auto to its “pre-accident physical condition”. Restoring the auto to its “pre-accident physical condition” does not require us to replace, restore or alter parts that are not damaged in the accident or loss, unless such part is needed for the operational safety of the vehicle; or

11. The amount shown in the Schedule or in the Declarations.

12. Any dispute with respect to the actual cash value of “your covered auto” or any “non-owned auto”, including its equipment, or the amount necessary to restore “your covered auto” or any “non-owned auto”, including its equipment, to its “pre-accident physical condition”, including disputes concerning the parts we have selected in making that determination, shall be resolved pursuant to the binding appraisal process set forth in the “APPRAISAL” section below in this Part D of your Policy.

However, the most we will pay for loss to:

3. Any “non-owned auto” which is a trailer is $500:

4. Equipment designed solely for the reproduction of sound, including any accessories used with such equipment, which is installed in locations not used by the auto manufacturer for installation of such equipment or accessories, is $1,000.

E. An adjustment for depreciation and physical condition will be made in determining actual cash value in the event of a total loss.

G. If a repair or replacement part restores the auto to better than its “pre-accident physical condition”, we will not pay for the amount of the “betterment”.

H. When used in this Part D, the terms listed below shall mean the following:

9. “Betterment”—The amount of increase to the pre-accident or pre-loss cash value of an auto attributed to the use of replacement parts which are of a type that are normally subject to repair and replacement during the useful life of an auto including but not limited to tires and batteries.

10. “Nonoriginal equipment manufacturer aftermarket crash parts”—The replacement part for a nonmechanical sheet metal part or plastic part that constitutes part of the exterior of a motor vehicle, including but not limited to, an inner and outer panel, and which was not made by or for the manufacturer of the motor vehicle.

11. “Original equipment manufacturer crash parts”—The replacement part for a nonmechanical sheet metal part or plastic part that constitutes part of the exterior of a motor vehicle, including but not limited to, an inner and outer panel, and which was made by or for the manufacturer of the motor vehicle.

12. “Pre-accident physical condition”—The operational safety, function and appearance of the auto immediately prior to when the damage in question was sustained.

PAYMENT OF LOSS

A. At our option we may:

(7) Pay either to replace or to repair “your covered auto” or “non owned auto”, including its equipment, but subject to the Limit of Liability set forth in this Part D;

(8) Return the stolen property, at our expense; or

(9) Take all or any part of the damaged or stolen property at an agreed or appraised value.

F. If we pay to replace “your covered auto” or any “non-owned auto” we will pay the applicable sales tax on the replacement cost of the auto.

G. If we return the stolen property at our expense, we will pay for any damage that results to the auto from the theft subject to the Limit of Liability set forth in this Part D.

A typical endorsement for the amendment of a personal policy allowing the use of allowable parts, generated by the method and apparatus of FIGS. 1, 2, and 3 for the state of New York follows:

### AMENDMENT OF POLICY PROVISIONS—NEW YORK

### Personal Auto Policy

With respect to coverage provided by this endorsement, the provisions of your policy apply except as modified by this endorsement.

The terms and conditions of your policy are amended as indicated below.

### PART D—COVERAGE FOR DAMAGE TO YOUR AUTO

The LIMIT OF LIABILITY and PAYMENT OF LOSS sections of Part D of your policy are replaced with the following:

LIMIT OF LIABILITY

F. Our limit of liability for loss will be the lesser of:

13. The actual cash value of “your covered auto” or any “non-owned auto”, including its equipment; or

14. The amount necessary to restore “your covered auto” or “any non-owned auto”, including its equipment, to its “pre-accident physical condition”. The determination of the amount necessary to restore the auto to its “pre-accident physical condition” may, in our sole discretion, be based upon the use of “nonoriginal equipment manufacturer aftermarket crash parts” (“non-OEM parts”), “original equipment manufacturer crash parts” (“OEM parts”), reconditioned parts, restoration parts, used parts or any other repair or part, whether or not any such part was made by or for the original manufacturer or distributor of the auto, that will restore the auto to its “pre-accident physical condition”. We will only specify the use of “non-OEM parts” in our repair estimate which have been duly certified by a qualified certifying entity acceptable to the New York Superintendent of Insurance and which equal or exceed the comparable “OEM part” in terms of fit, form, finish quality and performance. Restoring the auto to its “pre-accident physical condition” does not require us to replace, restore or alter parts that are not damaged in the accident or loss, unless such part is needed for the operational safety of the vehicle; or

15. The amount shown in the Schedule or in the Delcarations.

16. Any dispute with respect to the actual cash value of “your covered auto” or any “non-owned auto”, including its equipment, or the amount necessary to restore “your covered auto” or any “non-owned auto”, including its equipment, to its “pre-accident physical condition”, including disputes concerning the parts we have selected in making that determination, shall be resolved pursuant to the binding appraisal process set forth in the “APPRAISAL” section below in this Part D of your Policy.

However, the most we will pay for loss to any “non-owned auto” which is a trailer is $500.

G. An adjustment for depreciation and physical condition will be made in determining actual cash value in the event of a total loss.

I. If a repair or replacement part restores the auto to better than its “pre-accident physical condition”, we will not pay for the amount of the “betterment”.

J. When used in this Part D, the terms listed below shall mean the following:

13. “Betterment”—The amount of increase to the pre-accident or pre-loss cash value of an auto attributed to the use of replacement parts which are of a type that are normally subject to repair and replacement during the useful life of the insured auto including but not limited to tires and batteries. Our determination of the deduction for “betterment” will be the lesser of; a) an amount equal to the proportion that the expired life of the part, to be repaired or replaced, bears to the normal useful life of that part; or b) the amount by which the resale value of the motor vehicle is increased by the repair or replacement.

14. “Nonoriginal equipment manufacturer aftermarket crash parts”—A part of a motor vehicle which is made of sheet metal, plastic, fiberglass or similar material, including a door, fender, panel, bumper, hood, floor or trunk , but not including windows or hubcaps and constitutes or provides support for the motor vehicle's exterior which is manufactured or distributed (including any entity supplying the required warranty other than a manufacturer) by any entity that produces or markets, under its own name, crash parts for use in motor vehicles which it does not manufacture or distribute.

15. “Original equipment manufacturer crash parts”—A part of a motor vehicle which is made of sheet metal, plastic, fiberglass or similar material, including a door, fender, panel, bumper, hood, floor or trunk , but not including windows or hubcaps and constitutes or provides support for the motor vehicle's exterior which is manufactured or distributed by a manufacturer or distributor that produces or markets, under its own name, crash parts for use in motor vehicles that it manufactures or distributes under its own name.

16. “Pre-accident physical condition”—The operational safety, function and appearance of the auto immediately prior to when the damage in question was sustained.

PAYMENT OF LOSS

A. At our option we may:

(10) Pay either to replace or to repair “your covered auto” or “non owned auto”, including its equipment, but subject to the Limit of Liability set forth in this Part D;

(11) Return the stolen property, at our expense; or

(12) Take all or any part of the damaged or stolen property at an agreed or appraised value.

H. If we pay to replace “your covered auto” or any “non-owned auto” we will pay the applicable sales tax on the replacement cost of the auto.

I. If we return the stolen property at our expense, we will pay for any damage that results to the auto from the theft subject to the Limit of Liability set forth in this Part D.

A commercial line endorsement may be issued in any state for which there is specific need. An example of a typical endorsement for the amendment of a commercial policy allowing the use of allowable parts, generated by the method and apparatus of FIGS. 1, 2, and 3 for the state of Pennsylvania follows:

### PENNSYLVANIA CHANGES—

A. PHYSICAL DAMAGE COVERAGE AMENDMENT

THIS ENDORSEMENT CHANGES THE POLICY. PLEASE READ IT CAREFULLY.

With respect to coverage provided by this endorsement, the provisions of the Coverage Form apply unless modified by the endorsement.

The terms and conditions of this policy are amended as indicated below:

LIMIT OF INSURANCE

A. SECTION III—PHYSICAL DAMAGE COVERAGE, Paragraph C. Limit Of Insurance in the BUSINESS AUTO COVERAGE FORM; SECTION II—PHYSICAL DAMAGE COVERAGE, Paragraph C. Limit Of Insurance in the BUSINESS AUTO PHYSICAL DAMAGE COVERAGE FORM; and SECTION IV—PHYSICAL DAMAGE COVERAGE, Paragraph C. Limits Of Insurance in the MOTOR CARRIER AND TRUCKERS COVERAGE FORMS are replaced by the following:

1. Limit Of Insurance

1. The most we will pay for “loss” in any one “accident” is the lesser of:

a. The actual cash value of the damaged or stolen covered “auto” or its equipment immediately prior to the “loss”; or

b. The amount necessary to restore a covered “auto” or its equipment, to its “pre-damaged physical condition”. The determination of the amount necessary to restore the “auto” to its “pre-damaged physical condition” may, in our sole discretion, be based upon the use of “nonoriginal equipment manufacturer aftermarket crash parts”, “original equipment manufacturer crash parts”, reconditioned parts, restoration parts, used parts or any repair or part, whether or not any such part was made by or for the original manufacturer or distributor of the “auto”, that will restore the “auto” to its “pre-damaged physical condition”. Restoring the “auto” to its “pre-damaged physical condition” does not require us to replace, restore or alter parts that are not damaged in the accident or “loss”, unless such part is needed for the operational safety of the vehicle.

c. Any dispute with respect to the actual cash value of a covered “auto” or its equipment, or the amount necessary to restore a covered “auto” or its equipment, to its “pre-damaged physical condition”, including disputes concerning the parts we have selected in making that determination, shall be resolved pursuant to the binding appraisal process set forth in Section IV, Sub-Paragraph A.1, “LOSS CONDITIONS-APPRAISAL FOR PHYSICAL DAMAGE LOSS”, of the BUSINESS AUTO COVERAGE FORM; Section III, Sub-paragraph A.1, “LOSS CONDITIONS—APPRAISAL”, of the BUSINESS AUTO PHYSICAL DAMAGE COVERAGE FORM; or Section V, Sub-paragraph A.1, “LOSS CONDITIONS—APPRAISAL FOR PHYSICAL DAMAGE LOSS”, of the MOTOR CARRIER and TRUCKERS COVERAGE FORMS.

2.An adjustment for depreciation and physical condition will be made in determining actual cash value in the event of a total “loss”.

3. If a repair or replacement part restores the “auto” to better than its “pre-damaged physical condition”, we will not pay for the amount of the “betterment”.

B. SECTION IV -PHYSICAL DAMAGE COVERAGE, Paragraph C. Limits Of Insurance in the GARAGE COVERAGE FORM is replaced by the following:

C. Limit Of Insurance

1. The most we will pay for “loss” to any one covered “auto” is the lesser of:

a. The actual cash value of the damaged or stolen covered “auto” or its equipment immediately prior to the “loss”; or

b. The amount necessary to restore a covered “auto” or its equipment, to its “pre-damaged physical condition”. The determination of the amount necessary to restore the “auto” to its “pre-damaged physical condition” may, in our sole discretion, be based upon the use of “nonoriginal equipment manufacturer aftermarket crash parts”, “original equipment manufacturer crash parts”, reconditioned parts, restoration parts, used parts or any repair or part, whether or not any such part was made by or for the original manufacturer or distributor of the “auto”, that will restore the “auto” to its “pre-damaged physical condition”. Restoring the “auto” to its “pre-damaged physical condition” does not require us to replace, restore or alter parts that are not damaged in the accident or “loss”, unless such part is needed for the operational safety of the vehicle.

c. Any dispute with respect to the actual cash value of a covered “auto” or its equipment, or the amount necessary to restore a covered “auto” or its equipment, to its “pre-damaged physical condition”, including disputes concerning the parts we have selected in making that determination, shall be resolved pursuant to the binding appraisal process set forth in Section V, Sub-Paragraph A.1., “LOSS CONDITIONS—APPRAISAL FOR PHYSICAL DAMAGE LOSS”, of the Coverage Form.

2. An adjustment for depreciation and physical condition will be made in determining actual cash value in the event of a total “loss”.

3. If a repair or replacement part restores the “auto” to better than its “pre-damaged physical condition”, we will not pay for the amount of the “betterment”.

4. For those businesses shown in the Declarations as “auto” dealerships, the following provisions also apply:

a. Regardless of the number of covered “autos” involved in the “loss”, the most we will pay for all “loss” at any one location is the amount shown in the Auto Dealers Supplementary Schedule for that location. Regardless of the number of covered “autos” involved in the “loss”, the most we will pay for all “loss” in transit is the amount shown in the Auto Dealers Supplementary Schedule for “loss” in transit.

b. Quarterly Or Monthly Reporting Premium Basis

If, on the date of your last report, the actual value of the covered “autos” at the “loss” location exceeds what you last reported, when a “loss” occurs we will pay only a percentage of what we would otherwise be obligated to pay. We will determine this percentage by dividing your total reported value for the involved location by the value you actually had on the date of your last report.

If the last report due is delinquent on the date of “loss”, the most we will pay will not exceed 75 percent of the Limit Of Insurance shown in the Auto Dealers Supplementary Schedule for the applicable location.

c. Non-Reporting Premium Basis

If, when a “loss” occurs, the total value of your covered “autos” exceeds the Limit Of Insurance shown in the Declarations, we will pay only a percentage of what we would otherwise be obligated to pay. We will determine this percentage by dividing the limit by the total values you actually had when “loss” occurred.

a. LOSS CONDITIONS

Sub-Paragraph A.4., Loss Payment—Physical Damage Coverages in SECTION IV—BUSINESS AUTO CONDITIONS in the BUSINESS AUTO COVERAGE FORM; Sub-paragraph A.4., Loss Payment in Section III—BUSINESS AUTO CONDITIONS in the BUSINESS AUTO PHYSICAL DAMAGE COVERAGE FORM; and Sub-Paragraph A.4., Loss Payment—Physical Damage Coverages in SECTION V—GARAGE CONDITIONS, MOTOR CARRIER CONDITIONS or TRUCKERS CONDITIONS in the GARAGE, MOTOR CARRIER AND TRUCKERS COVERAGE FORMS are replaced by the following:

4. Loss Payment—Physical Damage Coverages

a. At our option, we may:

(1) Pay either to replace or to repair the damaged or stolen covered “auto” or its equipment, but subject to the Limit Of Insurance set forth above;

(2) Return the stolen property, at our expense; or

(3) Take all or any part of the damaged or stolen property at an agreed or appraised value.

b. If we pay to replace a covered “auto”, we will pay the applicable sales tax on the replacement cost of the “auto”.

c. If we return the stolen property at our expense, we will pay for any damage that results to the “auto” from the theft subject to the Limit Of Insurance set forth above.

DEFINITIONS

The following definitions are added to SECTION V—DEFINITIONS in the BUSINESS AUTO COVERAGE FORM; SECTION IV—DEFINITIONS in the BUSINESS AUTO PHYSICAL DAMAGE COVERAGE FORM; and SECTION VI—DEFINITIONS in the GARAGE, MOTOR CARRIER AND TRUCKERS COVERAGE FORMS:

“Betterment” means the amount of increase to the pre-damaged or pre-loss cash value of an “auto” attributed to the use of replacement parts which are of a type that are normally subject to repair and replacement during the useful life of an “auto” including but not limited to tires and batteries.

“Nonoriginal equipment manufacturer aftermarket crash parts” means the replacement part, either new or used, for any of the nonmechanical parts that generally constitute the exterior of an “auto”, including but not limited to, inner and outer panels, and which was not made by or for the manufacturer of the “auto”.

“Original equipment manufacturer crash parts” means the replacement part, either new or used, for any of the nonmechanical parts that generally constitute the exterior of an “auto”, including but not limited to, inner and outer panels, which was made by or for the manufacturer of the “auto”.

“Pre-damaged physical condition” means the operational safety, function and appearance of the “auto” immediately prior to when the damage in question was sustained

A typical endorsement for providing certain enhancements to the coverages provided by a commercial auto policy and which allow for the use of allowable parts, generated by the method and apparatus of FIGS. 1, 2, and 3 follows:

THIS ENDORSEMENT CHANGES THE POLICY. PLEASE READ IT CAREFULLY

### COMMERCIAL AUTOMOBILE ENHANCEMENT ENDORSEMENT

This endorsement modifies insurance provided under the following:

BUSINESS AUTO COVERAGE FORM (CA0001)

GARAGE COVERAGE FORM (CA0005)

The terms and conditions of this policy are amended as indicated below:

1. SECTION II—LIABILITY COVERAGE is amended as follows:

II. BROAD FORM INSURED

Paragraph 1. Who Is An Insured of the BUSINESS AUTO COVERAGE FORM, and Paragraph 3. Who Is An Insured of the GARAGE COVERAGE FORM, under A. Coverage are amended as follows:

For covered “autos”, the Named Insured shown in the Declarations is amended to include:

a. Any legally incorporated subsidiary in which you own more than 50% of the voting stock on the effective date of the Coverage Form. However, the Named Insured does not include any subsidiary that is an “insured” under any other automobile policy or would be an “insured” under such a policy but for its termination or the exhaustion of its Limit of Insurance.

b. Any organization that is newly acquired or formed by you during the policy period and over which you maintain majority ownership. However, the Named Insured does not include any newly formed or acquired organization:

(1) That is a joint venture or partnership,

(2) That is an “insured” under any other automobile policy,

(3) That has exhausted its Limit of Insurance under any other automobile policy, or

(4) That has been acquired or formed by you for more than 180 days, or after the end of the policy period, unless you have given us notice of the acquisition or formation.

Coverage does not apply to “bodily injury” or “property damage” that results from an “accident” that occurred before you formed or acquired the organization, or an “accident” that occurs before or after the end of the policy period.

B. EMPLOYEES AS INSUREDS

For Covered “Autos”, Paragraph 1. Who Is an Insured of the BUSINESS AUTO COVERAGE FORM, and Paragraph 3. Who Is an Insured of the GARAGE COVERAGE FORM, under A. Coverage are amended to include:

Any “employee” of yours while using a covered “auto” you don't own, hire or borrow in your business or your personal affairs.

AMENDED LIABILITY COVERAGE EXTENSIONS

1. Supplementary Payments a.(2) and a.(4) of Paragraph 2. Coverage Extensions of the BUSINESS AUTO COVERAGE FORM, and Paragraph 4. Coverage Extensions of the GARAGE COVERAGE FORM, are replaced by the following:

(2) Up to $2,500 for cost of bail bonds (including bonds for related traffic law violations) required because of an “accident” we cover. We do not have to furnish these bonds.

(4) All reasonable expenses incurred by the “insured” at our request, including actual loss of earnings up to $300 a day because of time off from work.

2. Supplementary Payment a.(7) is added to Paragraph 2. Coverage Extensions of the BUSINESS AUTO COVERAGE FORM, and Paragraph 4. Coverage Extensions of the GARAGE COVERAGE FORM as follows:

(7) Prejudgement interest awarded against the “insured” on that part of the judgement we pay. If we make an offer to pay the applicable Limit of Insurance, we will not pay any prejudgement interest based on that period of time after the offer.

(1) D. AMENDED FELLOW EMPLOYEE LIABILITY EXCLUSION

Paragraph B.5. Exclusions—Fellow Employee does not apply if the “bodily injury” results from the use of a covered “auto” you own or hire. The insurance provided under this provision is excess over any other collectible insurance.

II. SECTION III—PHYSICAL DAMAGE COVERAGE of the BUSINESS AUTO COVERAGE FORM and SECTION IV—PHYSICAL DAMAGE COVERAGE of the GARAGE COVERAGE FORM are amended as follows:

III. A. HIRED AUTO PHYSICAL DAMAGE COVERAGE

If hired “autos” are covered “autos” for Liability Coverage and if Comprehensive, Specified Causes of Loss, or Collision Coverages are provided under this Coverage Form for any “auto” you own, then the Physical Damage Coverages provided are extended to “autos” you hire, subject to the following limit:

The most we will pay for any one “accident” or “loss” to any hired “auto” is the lesser of the actual cash value of the hired “auto” or the cost to restore the hired “auto” to its “pre-accident physical condition”, minus a deductible, up to a maximum limit of insurance of $50,000. The deductible will be equal to the largest deductible applicable to any owned “auto” for that coverage. No deductible applies to “loss” caused by fire or lightning. Hired Auto Physical Damage coverage is excess over any other collectible insurance. Subject to the above limit, deductible and excess provisions, we will provide coverage equal to the broadest coverage applicable to any covered “auto” you own.

IV. B. AMENDED PHYSICAL DAMAGE COVERAGE EXTENSIONS

Paragraph 4. Coverage Extension of A. Coverage is replaced by the following:

4. Coverage Extensions

a. Transportation Expenses

We will pay up to $50 per day to a maximum of $1,500 for temporary transportation expense incurred by you because of the total theft of a covered “auto”. We will pay only for those covered “autos” for which you carry either Comprehensive or Specified Causes Of Loss Coverage. We will pay for temporary transportation expenses incurred during the period beginning 24 hours after the theft and ending, regardless of the policy's expiration, when the covered “auto” is returned to use or we pay for its “loss”.

b. Loss Of Use Expenses

For Hired Auto Physical Damage, we will pay expenses for which an “insured” becomes legally responsible to pay for loss of use of a vehicle rented or hired without a driver, under a written rental contract or agreement. We will pay for loss of use expenses if caused by:

(1) Other than collision only if the Declarations indicate that Comprehensive Coverage is provided for any covered “auto”;

(2) Specified Causes of Loss only if the Declarations indicate that Specified Causes Of Loss Coverage is provided for any covered “auto”; or

(3) Collision only if the Declarations indicate that Collision Coverage is provided for any covered “auto”.

However, the most we will pay for any expenses for loss of use is $50 per day, to a maximum of $1,500.

C. Extra Expense

We will also pay for the expense of returning a stolen covered “auto” to you.

C. PERSONAL EFFECTS COVERAGE

The following is added to Paragraph A. Coverage:

5. We will pay up to $500 for “loss” to wearing apparel and other personal effects which are:

a. Owned by an “insured”; and

b. In or on your covered “auto”.

This coverage applies only in the event of a total theft of your covered “auto”. No deductible applies to this coverage.

V. D. PHYSICAL DAMAGE—ACCIDENTAL DISCHARGE OF AN AIR BAG

The following is added to Exclusions, Paragraph B.3. of the BUSINESS AUTO COVERAGE FORM, and Paragraph B.6. of the GARAGE COVERAGE FORM:

However, this exclusion does not apply to the accidental discharge of an air bag that is caused by mechanical breakdown.

E. FINANCED AUTO GAP COVERAGE

In the event of a “total loss” to a covered auto, we will pay your additional legal obligation to the lessor or leinholder for any difference between the actual cash value of the covered “auto” at the time of the “loss” and the “outstanding balance” of the lease or loan. This coverage applies only if the lessor or leinholder is shown as a Loss Payee under separate endorsement attached to this policy.

“Outstanding balance” means the amount you owe on the lease at the time of “total loss” less any amounts representing:

1. Taxes;

2. Overdue payments;

3. Penalties, interest or charges resulting from overdue payments;

4. Additional mileage, excess use or abnormal wear and tear charges;

5. Lease or loan termination fees;

6. Costs for extended warranties, Credit Life Insurance, Health, Accident or Disability Insurance purchased with the loan or lease;

7. Carry-over, roll-over or transfer balances from previous leases or loans;

8. Security deposits not refunded by the lessor or leinholder;

9. The dollar amount of any unrepaired damage which occurred prior to the “total loss” of a covered “auto”; and

10. Any refunds payable or paid to you as a result of the early termination of a lease or loan agreement or as a result of the early termination of any warranty or extended agreement on a covered “auto”.

“Total loss” means a “loss” in which the cost of repairs plus the salvage value exceeds the actual cash value.

F. DEDUCTIBLE AMENDMENTS

The following are added to paragraph D. Deductible of the BUSINESS AUTO COVERAGE FORM, and to paragraph D.2. Deductible—Non-Dealers Only Special Deductible Provision of the GARAGE COVERAGE FORM:

If another policy or coverage form that is not an automobile policy or coverage form issued by this Company applies to the same “accident”, the following applies:

1. If the deductible under this coverage is the smaller (or smallest) deductible, it will be waived;

2. If the deductible under this coverage is not the smaller (smallest) deductible, it will be reduced by the amount of the smaller (or smallest) deductible.

No deductible applies to glass damage if the glass is repaired, in a manner acceptable to us, rather than replaced.

III. SECTION IV—BUSINESS AUTO CONDITIONS of the BUSINESS AUTO COVERAGE FORM, and SECTION V—GARAGE CONDITIONS of the GARAGE COVERAGE FORM are amended as follows:

A. NOTICE AND KNOWLEDGE OF OCCURRENCE

1. Your obligation in Loss Condition A.2.a. relative to notification requirements applies only when the “accident” or “loss” is known to:

a. You, if you are an individual;

b. A partner, if you are a partnership;

c. A member, if you are a Limited Liability Company; or

d. An executive officer or insurance manager, if you are a corporation.

2. Your obligation in Loss Condition A.2.b. relative to providing us with documents concerning a claim or “suit” will not be considered breached unless the breach occurs after such claim or “suit” is known to:

a. You, if you are an individual;

b. A partner, if you are a partnership;

c. A member, if you are a Limited Liability Company; or

d. An executive officer or insurance manager, if you are a corporation.

B. UNINTENTIONAL FAILURE TO DISCLOSE HAZARDS

The following is added to paragraph B.2. General Conditions—Concealment, Misrepresentation Or Fraud:

If you unintentionally fail to disclose any hazards existing at the inception date of your policy, we will not deny coverage under this Coverage Form because of such failure.

C. HIRED CAR—COVERAGE TERRITORY

Item e.(1) of Paragraph 7. General Conditions—Policy Period, Coverage Territory is replaced by the following:

(1) A covered “auto” is leased, hired, rented or borrowed without a driver for a period of 30 days or less; and

a. IV. SECTION V—DEFINITIONS of the BUSINESS AUTO COVERAGE FORM and SECTION VI—DEFINITIONS of the GARAGE COVERAGE FORM are amended as follows:

A. Paragraph C. is replaced by the following:

C. “Bodily injury” means bodily injury, sickness or disease sustained by any person, including mental anguish and death resulting from any of these.

B. The following is added:

“Pre-accident physical condition” means the operational safety, function and appearance of the “auto” immediately prior to when the damage in question was sustained.

All policy provisions not in conflict with this endorsement shall continue to apply. This endorsement is a valid part of the policy when the form number is shown on the declarations.

An endorsement for a stated amount insurance notification may be generated in any state for which the carrier has a license to operate, and in which the policyholder has a need to be informed of changes to a policy. As an example, a typical endorsement for communicating certain limits of liability to the policyholder for the state of Pennsylvania is as follows:

THIS ENDORSEMENT CHANGES THE POLICY. PLEASE READ IT CAREFULLY.

VI. STATED AMOUNT INSURANCE—PENNSYLVANIA

This endorsement modifies insurance provided under the following:

BUSINESS AUTO COVERAGE FORM

BUSINESS AUTO PHYSICAL DAMAGE COVERAGE FORM

GARAGE COVERAGE FORM

MOTOR CARRIER COVERAGE FORM

TRUCKERS COVERAGE FORM

With respect to coverage provided by this endorsement, the provisions of the Coverage Form apply unless modified by the endorsement.

This endorsement changes the policy effective on the inception date of the policy unless another date is indicated below.

| | |
|---|---|
| Endorsement Effective: | Countersigned by: |
| | (Authorized |
| | Representative) |
| Named Insured: | |

A. SCHEDULE

The insurance provided by this endorsement is re-
duced by the following deductible(s):

| B. Vehicle | | | | |
|---|---|---|---|---|
| Number | Coverage | Limit of Insurance | | Premium |
| | | $ | Less | |
| | | $ | | |
| | | | Deductible | |
| | | $ | Less | |
| | | $ | | |
| | | | Deductible | |
| | | $ | Less | |
| | | $ | | |
| | | | Deductible | |
| | | $ | Less | |
| | | $ | | |
| | | | Deductible | |
| | | | Total | |

Premium

1. Note
The amount shown in the Schedule or in the Decla-
rations is not necessarily the amount you will re-
ceive at the time of “loss” for the described
property. Please refer to the Limit Of Insurance
And Deductible Provision which follows:

Designation or Description of Covered “Autos”

| | | |
|---|---|---|
| Vehicle Number | Model Year | Trade Name and Model |

(If no entry appears above, information to complete this endorsement will be shown in the Declarations as applicable to this endorsement.)

A. This endorsement provides only those coverages where a premium is shown in the Schedule. Each of these coverages applies only to the vehicles shown as covered “autos.”

B. For a covered “auto” described in the Schedule, the Physical Damage Coverage Limit(s) Of Insurance is replaced by the following:

a. Limit Of Insurance and Deductible

4. The most we will pay for “loss” in any one “accident” is the least of the following amounts minus any applicable deductible shown in the Schedule:

d. The actual cash value of the damaged or stolen covered “auto” or its equipment immediately prior to the “loss”;

e. The amount necessary to restore a covered “auto” or its equipment, to its “pre-damaged physical condition”. The determination of the amount necessary to restore the “auto” to its “pre-damaged physical condition” may, in our sole discretion, be based upon the use of “nonoriginal equipment manufacturer aftermarket crash parts”, “original equipment manufacturer crash parts”, reconditioned parts, restoration parts, used parts or any repair or part, whether or not any such part was made by or for the original manufacturer or distributor of the “auto”, that will restore the “auto” to its “Pre-damaged physical condition”. Restoring the “auto” to its “pre-damaged physical condition” does not require us to replace, restore or alter parts that are not damaged in the accident or “loss”, unless such part is needed for the operational safety of the vehicle; or

f. The amount shown in the Schedule.

g. Any dispute with respect to the actual cash value of a covered “auto” or its equipment, or the amount necessary to restore a covered “auto” or its equipment, to its “pre-damaged physical condition”, including disputes concerning the parts we have selected in making that determination, shall be resolved pursuant to the binding appraisal process set forth in Section III, Sub-Paragraph A.1, “LOSS CONDITIONS—APPRAISAL”, of the BUSINESS AUTO PHYSICAL DAMAGE COVERAGE FORM; Section IV, Sub-Paragraph A.1, “LOSS CONDITIONS—APPRAISAL FOR PHYSICAL DAMAGE LOSS”, of the BUSINESS AUTO COVERAGE FORM; or Section V, Sub-Paragraph A.1, “LOSS CONDITIONS—APPRAISAL FOR PHYSICAL DAMAGE LOSS”, of the GARAGE, MOTOR CARRIER and TRUCKERS COVERAGE FORMS.

5.An adjustment for depreciation and physical condition will be made in determining actual cash value in the event of a total “loss”.

6. If a repair or replacement part restores the “auto” to better than its “pre-damaged physical condition”, we will not pay for the amount of the “betterment”.

C. Deductible

For each covered “auto”, our obligation to pay for, repair, return or replace damaged or stolen property will be reduced by the applicable deductible shown in the Declarations or Schedule. Any Comprehensive Coverage Deductible shown in the Declarations or Schedule does not apply to “loss” caused by fire or lightning.

D. Loss Conditions

The Loss Payment paragraph of the BUSINESS AUTO PHYSICAL DAMAGE COVERAGE FORM and the Loss Payment—Physical Damage Coverages paragraph of the BUSINESS AUTO, GARAGE, MOTOR CARRIER AND TRUCKERS COVERAGE FORMS are replaced by the following:

4. Loss Payment

a. At our option, we may:

(4) Pay either to replace or to repair the damaged or stolen covered “auto” or its equipment, but subject to the Limit Of Insurance set forth above;

(5) Return the stolen property, at our expense; or

(6) Take all or any part of the damaged or stolen property at an agreed or appraised value.

d. If we pay to replace a covered “auto”, we will pay the applicable sales tax on the replacement cost of the “auto”.

e. If we return the stolen property at our expense, we will pay for any damage that results to the “auto” from the theft subject to the Limit Of Insurance set forth above.

E. Definitions

When used in this Endorsement, the following terms shall have the following meanings:

“Betterment” means the amount of increase to the pre-damaged or pre-loss cash value of an “auto” attributed to the use of replacement parts which are of a type that are normally subject to repair and replacement during the useful life of an “auto” including but not limited to tires and batteries.

“Nonoriginal equipment manufacturer aftermarket crash parts” means the replacement part, either new or used, for any of the nonmechanical parts that generally constitute the exterior of an “auto”, including but not limited to, inner and outer panels, and which was not made by or for the manufacturer of the auto.

“Original equipment manufacturer crash parts” means the replacement part, either new or used, for any of the nonmechanical parts that generally constitute the exterior of an “auto”, including but not limited to, inner and outer panels, which was made by or for the manufacturer of the “auto”.

“Pre-damaged physical condition” means the operational safety, function and appearance of the “auto” immediately prior to when the damage in question was sustained

It will be apparent to those skilled in the art that various modifications and variations may be made in the apparatus and method of the present invention without departing from the spirit or scope of the invention. Thus, it is intended that the present invention cover the modification and variations of this invention provided they come within the scope of the this invention and its equivalents.

What is claimed is:

1. A method of establishing a policy modification utilizing allowable parts in automobile repair in accordance with an insurance policy, comprising;
establishing a need to modify the policy;
identifying a state of operation for the policy;
identifying controlling legal authority for the policy;
modifying the policy;
wherein restoration of an automobile to a pre-damage condition comprises using one or more of the group consisting of nonoriginal equipment manufacturer aftermarket crash parts, original equipment manufacturer crash parts, reconditioned parts, restoration parts, used parts, and repair parts sufficient to restore the automobile to its pre-damaged condition, and wherein said modifying comprises a filtering of a comparison of the controlling legal authority to the one or more of the group.

2. The method of claim 1, further comprising generating a dispute clause in accordance with the modification.

3. The method of claim 2, further comprising selecting language from an ISO policy relating to adjustments for depreciation and physical condition and betterment restoration for said generating.

4. The method of claim 3, further comprising filing the modification with the state of operation.

5. The method of claim 4, further comprising informing policyholders of the modification after state approval of said filing of the modification.
